(19) United States
(12) Patent Application Publication
(10) Pub. No.: US 2011/0161133 A1
(43) Pub. Date: Jun. 30, 2011

(54) Planning and Performing Drilling Operations

(75) Inventors: Catheryn Staveley, Houston, TX (US); Russ Sagert, Katy, TX (US); Slavo Pastor, Houston, TX (US)

(73) Assignee: SCHLUMBERGER TECHNOLOGY CORPORATION, Sugar Land, TX (US)

(21) Appl. No.: 12/831,960

(22) Filed: Jul. 7, 2010

Related U.S. Application Data
(63) Continuation-in-part of application No. 12/237,872, filed on Sep. 25, 2008.
(60) Provisional application No. 61/224,096, filed on Jul. 9, 2009.
(60) Provisional application No. 60/995,840, filed on Sep. 29, 2007.

(51) Int. Cl. G06Q 10/00; G06G 7/48; G06F 17/00

(52) U.S. Cl. 705/7.28; 703/10; 706/59; 705/7.11

(57) ABSTRACT

The present disclosure relates to dynamically incorporating and economically validating drilling decisions. A computer system having a memory and central processing unit is provided and a knowledge store residing in the computer system is populated with data. The data may include surface drilling parameter data, bottomhole assembly data, bit records, measurement-while-chilling data, logging-while-drilling data, drilling event data, and lessons learned data. The data may be correlated data from one or more offset wells. One or more computerized static or dynamic contextual earth models are provided and used to dynamically incorporate and economically validate the drilling decisions. The one or more earth models can be updated in real-time.

### CROSS-REFERENCE TO OTHER APPLICATIONS

This application claims, under 35 U.S.C. §119(e), priority to and the benefit of U.S. Provisional Application No. 61/224,096, filed Jul. 9, 2009. This application is a continuation in part, and claims under 35 U.S.C. §120, priority to and the benefit of U.S. patent application Ser. No. 12/237,872, filed Sep. 25, 2008, the contents of which is hereby fully incorporated by reference, for all purposes. U.S. patent application No. 12/237,872 claims, under 35 U.S.C. §119(e), priority to and the benefit of U.S. Provisional Application No. 60/995,840, filed Sep. 29, 2007.

### BACKGROUND

1. Technical Field

The present invention relates generally to petroleum exploration, exploitation, development, and production, as well as to water and carbon dioxide sequestration, and more particularly to a method and system to plan and perform drilling operations using real-time drilling data stores, simultaneous and correlated offset well data, and shared earth models.

2. Background Art

Present estimates place spending on oilfield drilling and completions operations at over $250 billion. With rig costs estimated to consume 37% of that spending, every effort to reduce rig time has a direct impact on the financial bottom line. Estimates of non-productive time (NPT) run from 15-40%, depending on the well type and operator. The causes of NPT are varied, and include technical and non-technical challenges, such as wellbore stability, stuck pipe, weather, supply chain logistics, crew efficiency, etc.

One way to reduce NPT is to improve fundamental data management. More particularly, one could improve the: (1) usability of already-collected data; (2) accessibility to relevant data; (3) ability to effectively correlate collected well data across multiple wells in a single view; (4) predictability of occurrence of an NPT event; and (5) association of NPT events with known NPT mitigation strategies. Such data may be used, for example, to predict downhole conditions and to make decisions concerning oilfield operations such as well placement and drilling.

Data from one or more wellbores may be analyzed to plan or predict various outcomes at a given wellbore. In some cases, the data from neighboring wellbores (also referred to as offset wells) with similar conditions or equipment are used to predict how a new well will perform. There are usually a large number of variables and large quantities of data to consider in analyzing wellbore operations. It is, therefore, often useful to model the behavior of the oilfield operation to determine the desired course of action. During the ongoing operations, the operating conditions may need adjustment as conditions change and new information is received.

### SUMMARY

The present disclosure relates to dynamically incorporating and economically validating drilling decisions. A computer system having a memory and central processing unit is provided and a knowledge store residing in the computer system is populated with data. The data may include surface drilling parameter data, bottomhole assembly data, bit records, measurement-while-drilling data, logging-while-drilling data, drilling event data, mitigation measures, and lessons learned data. The data may be correlated data from one or more offset wells. One or more computerized static and/or dynamic contextual earth models are provided and used to dynamically incorporate and economically validate the drilling decisions. The one or more earth models can be updated in real-time.

### BRIEF DESCRIPTION OF THE FIGURES

FIG. 1 shows a workflow to improve the drilling process, in accordance with an embodiment disclosed herein.

FIG. 2 shows an expanded workflow to improve the drilling process, in accordance with an embodiment disclosed herein.

FIG. 3 illustrates an example computing device in which various embodiments of the present disclosure can be implemented.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In general, embodiments disclosed herein exemplify a method and system to improve collaboration and analysis of real-time and historical drilling data to increase the cost-effectiveness of drilling efforts.

In one embodiment, a drilling knowledge store of correlated data from one or more offset wells is provided, including, but not limited to, any and/or all surface drilling parameter data, bottomhole assembly (BHA) information, bit records, measurement-while-drilling/logging-while-drilling (MWD/LWD) data, drilling events, lessons learned, best practices, successfully implemented mitigation methods, and so forth. Such data may be displayed side-by-side, allowing correlation by formation, depth, or time, and in one, two, or three dimensions. Also, the static or shared earth model can be dynamically displayed over the time of drilling and production. This is referred to herein as a 4D display. Moreover, besides using this data to better plan wells, the well position may be tracked with respect to an earth model and the earth model may be updated in real-time while drilling. Such a process facilitates the anticipation of problems, mitigation of risks, and reduction of rig time.

To be clear, the term “knowledge store”, as used above and below herein, is meant to include all information or data that can be related to or used with respect to a particular oilfield operation. In paragraph 82 of incorporated patent application Ser. No. 12/237,872 (referred to herein as “the Ser. No. 12/237,872 application”), a “database” is described as a storage facility or store for collecting data of any type. If properly interpreted in its broadest sense, that is what is intended here by “knowledge store”. However, to avoid possible misinterpretation from improperly limiting the term “data” (for example, to numerical information only), we use “knowledge store” to expressly expand the definition to include all types of information. For example, commentary describing specific events such as particular subsurface encounters, lessons learned, recommendations for future operations, etc. come within the definition of “knowledge store”. Paragraph 110 of the Ser. No. 12/237,872 application states the database may be provided with oilfield knowledge in addition to raw data and interpretation results, as well as any other desired information. Thus, if properly construed, the terms “database” and “knowledge store” are synonymous, and should be given their broadest interpretation in both applications. We shall use the terms interchangeably herein.

Another term that merits brief description is “4D”. The first three dimensions (e.g., 1D, 2D, 3D) are commonly understood to mean the three spatial dimensions that are integral to and common to our everyday experience. The term “4D” is generally understood by the scientific and engineering communities to mean the dimension of time. As used specifically herein, the term “4D” refers to similar operations or events being performed or observed at different times. For example, a seismic survey may be conducted prior to drilling a well, and then repeated some time later during the production phase of the well. The resulting interpretations can be compared to discern possible changes in the reservoir that occurred between the times of the two surveys. A further example is that of sampling or testing a well at two different periods of the well's lifecycle.

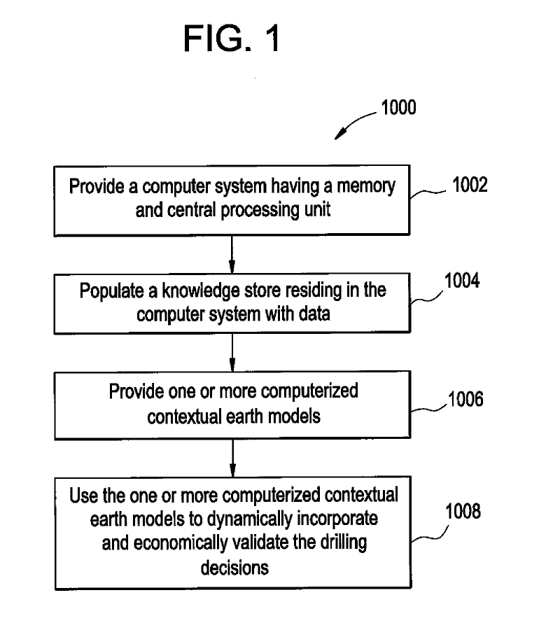

A representative example of a drilling operation is described in paragraph 36 and illustrated in FIG. 1B of the Ser. No. 12/237,872 application, and will not be repeated here. Particular reference is also made here to paragraphs 83-88 and FIG. 6B, and paragraphs 101-108 and FIG. 7B of the Ser. No. 12/237,872 application, as they specifically refer to the use of drilling modules in particular embodiments of a process system and bidirectional integrated system, respectively. Knowledge sharing between modules is described in paragraphs 125-126 of the Ser. No. 12/237,872 application. Examples and description of economic information and use of an economic model is found at least in paragraphs 71 and 104 of the Ser. No. 12/237,872 application.

In the above-described and perhaps other embodiments, earth modeling software may be used or incorporated, such as Schlumberger's PETREL® software. That software may be used to connect to a real-time data source, update the shared earth model, create a drilling data knowledge store, and perform offset well analysis for future well planning.

Operational efficiency can be improved by setting an environment to visualize and understand relationships between the drilling processes in the earth context. One can display drilling events in 1D, 2D, 3D, or 4D and correlate those events with geological properties to better understand and avoid problems when drilling.

The shared earth model can be driven by real-time data, allowing one to understand the full impact of freshly acquired geologic information on the well while it is being drilled. Surveillance using a shared earth model while drilling allows for effective cross-discipline collaboration in real time. Examples of cross-discipline collaboration include petrophysics, geology, geophysics, reservoir engineering, production geology, production engineering, and landman interaction. Real-time trajectory and log information may be imported into the earth model using, for example, WITSML (Wellsite Information Transfer Standard Markup Language) such that the new data can be visually analyzed and exploited. A real-time data link can connect to streaming real-time data via a well site monitoring and data delivery system. This allows a secure, real-time data link directly from the well site. The real-time data link can also connect other data sources to wells in the database, allowing one to load trajectory and log data. This data can be saved for later use.

Understanding in advance the potential problems that might be encountered when drilling a well allows one to design a well trajectory that avoids or minimizes those problems, while maximizing reservoir exposure. That presents a potential cost savings or risk mitigation opportunity. If a drilling engineer understands, in a geological context, the relationship between actual undesired drilling events (e.g., well control, mud losses, wellbore stability, stuck pipe, etc.), he or she can better mitigate or avoid the problems. For example, an engineer can design a drilling plan interactively by digitizing the planned well path directly in a 3D window, using various types of data, including raw seismic, formation property models, or flow simulation results. Well nodes can be edited in a 2D or 3D window or with a spreadsheet editor.

Risks and events can be entered directly into the database. and edited as needed. Such data can be migrated to a planned well, reclassified, and correlated to geology. Importing a drilling risk prediction model allows for a comprehensive view of simulated drilling risks alongside the event-driven drilling knowledge. Visualizing these risks and events in the context of the shared earth model enables the monitoring of the impact of changes in geology interpretation on the drilling process, thereby minimizing geologically driven risk. Identified risks can also be exported in WITSML format for proactive use in other tools used in real-time drilling so that team members can collaborate while drilling. Risk may be reduced by dynamically updating a common earth model with real-time drilling data. Offset well risks can also be correlated using a well section window or 3D window.

Numerous earth model realizations can be obtained to analyze different drilling scenarios or options, each with its own economic cost and possible economic production value. The best field development drilling scenario is not necessarily the cheapest option, or the one with the least risk. An operating company could choose to take on more risk and cost for a much greater potential production upside. This too is part of the offset well analysis for which an asset team is responsible.

As alluded to in the Background section, costs are associated with NPT events. Examples of those include supply chain logistics; crew efficiency, and operator efficiency. Offset well analyses using captured knowledge can be performed to optimize those NPT events.

Data points describing a new well can be shared. In addition, well trajectories and platform locations for a set of reservoir targets can be automatically generated to minimize the total cost of a drilling program. Targets defined as “must hit” data points for optimized well paths can be locked to platforms, and target-platform sets can be constrained by closed boundaries. For example, if automatically computed well trajectories are constrained by a user-defined dogleg severity, the output is a set of optimized trajectories extending from the reservoir back to the surface based on geometrical drilling constraints. Similarly, “must avoid” points or objects can be defined and the wellbore trajectory planned in accordance with those constraints.

A Drilling Difficulty Index (DDI) provides a first-pass evaluation of the relative difficulty that may be encountered in drilling a well. The total cost of a drilling project can be minimized by evaluating the cost for all possible scenarios. Manual wells plans can be designed quickly in 3D, for example, directly on seismic lines, property models, STOIIP (Stock Tank Oil Initially in Place) maps, and even simulation model results. Well path segments that exceed a user-specified dogleg severity can be displayed. Instant well reports and synthetic property logs can be created and well paths for use in drilling and reservoir simulation packages can be generated and exported.

One can monitor drill plan execution. in a proactive manner in real-time to ensure optimum well position, foresee potential risks when the actual well path trajectory is approaching a risk zone, and recognize deviations from planned well trajectory. Geological targets can be identified and the drilling uncertainty calculated and displayed in 3D as uncertainty cones or disks. Drilling events such as lessons learned, best practices, and risks encountered on offset wells, such as kicks, losses, high or low pressure zones, and other difficult drilling conditions can be easily imported into the drilling knowledge store.

Any asset team member, e.g., a geologist, can visualize and correlate events on the 3D and well section windows and thereby improve well proposals. Better collaboration among different discipline technical experts while drilling produces more feasible well proposals and drill plan modifications. Real-time and post-drilling data optimization and analysis software enhances well planning with knowledge correlation and creates better well proposals.

A workflow 1000 to improve the drilling process is depicted in FIG. 1. Workflow 1000 includes providing a computer system having a memory and central processing unit (step 1002). Step 1004 includes populating a drilling data knowledge store. The drilling data may be correlated, for example, by depth, time, or formation in 2D or 3D. Thus, different formats of data from different sources can all be viewed together. Lessons learned, drilling events, best practices, risks, and so forth can be captured and stored within the knowledge store. The knowledge store can be used to provide one or more computerized contextual earth models (step 1006). Collecting drilling data in real-time allows for up-to-the-minute modifications to a shared earth model.

Engineering calculations can be performed using various equations having drilling and earth property values as variables. Offset well data can be analyzed, and from such analyses, multiple wells can be displayed simultaneously, and correlated by time, depth, or formation in 2D or 3D. A drilling plan for current and future wells can be optimized using captured and stored data, lessons learned, etc. Anti-collision analysis surveys and trajectories can be shown in 3D view. Drilling data can be displayed within the context of a shared earth model. That allows drilling engineers to take advantage of earth model data and to account for properties such as faults, for example, when planning a drilling program. It also allows for the use of drilling knowledge by geologists, geophysicists, and reservoir engineers when working with well planners to avoid areas of high risk or low predicted production. Thus, step 1008 includes using the one or more computerized contextual earth models to dynamically incorporate and economically validate the drilling decisions.

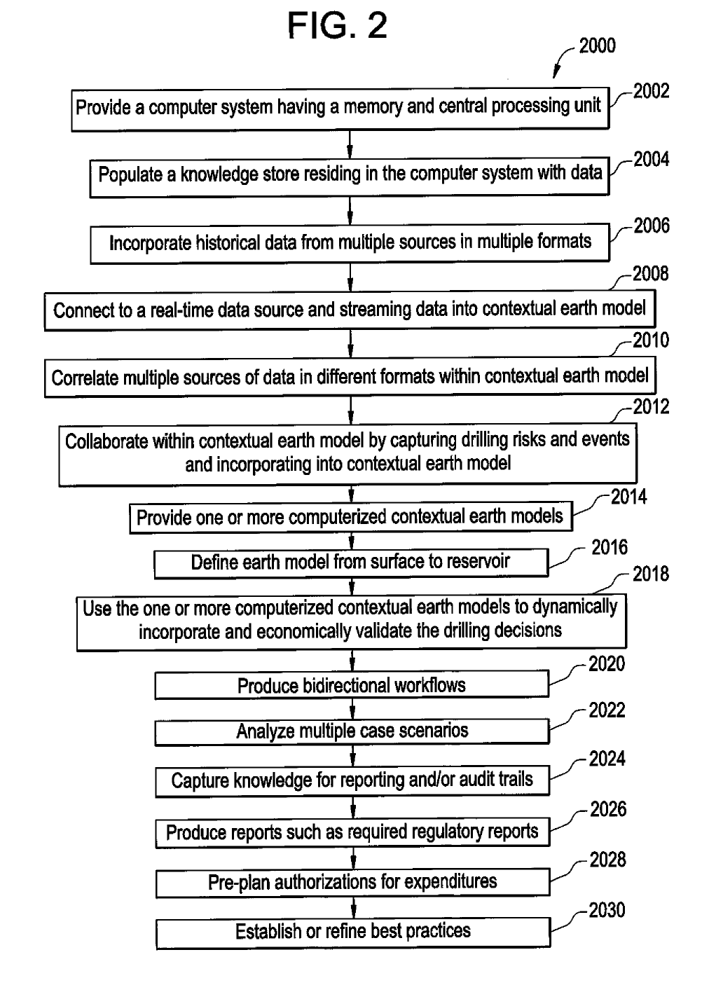

Workflow 1000 can be expanded to include other steps, as shown in workflow 2000 in FIG. 2. Workflow 2000 includes providing a computer system having a memory and central processing unit (step 2002), and populating a drilling data knowledge store (step 2004). The knowledge store may: (1) incorporate historical data from multiple sources in multiple formats (step 2006); (2) connect to a real-time data source and stream data (step 2008); and (3) correlate multiple sources of data in different formats (step 2010). Asset team members can collaborate within a contextual earth model by capturing drilling risks and events and incorporating those into the contextual earth model (step 2012). Thus, the knowledge store can be used to provide one or more computerized contextual earth models (step 2014). One or more of the earth models may be defined from the surface to the reservoir (step 2016).

The one or more computerized contextual earth models may be used to dynamically incorporate and economically validate the drilling decisions (step 2018). That can be done using bidirectional workflows (step 2020) and/or by analyzing multiple case scenarios (step 2022). Knowledge may be captured for reporting and/or audit trails (step 2024) and used to produce reports such as required regulatory reports (step 2026). Those or other reports may be used to pre-plan authorizations for expenditures (step 2028) and to establish or refine best practices (step 2030).

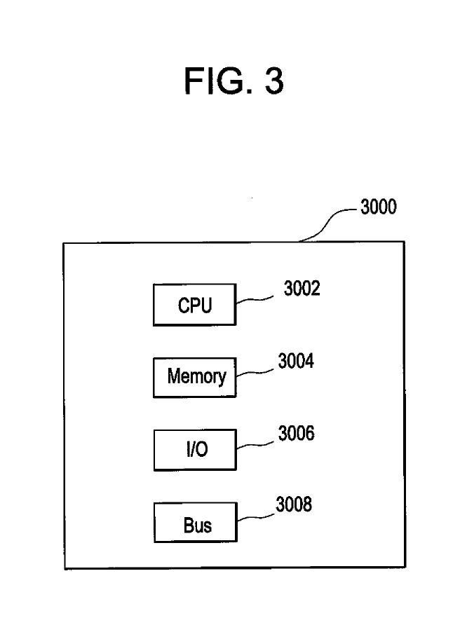

FIG. 3 illustrates an example computing device 3000 that can implement the various techniques described herein, and which may be representative, in whole or in part, of the elements described herein. Computing device 3000 is only one example of a computing device and is not intended to suggest any limitation as to scope of use or functionality of the computing device and/or its possible architectures. Neither should computing device 3000 be interpreted as having any dependency or requirement relating to any one or combination of components illustrated in the example computing device 3000.

Computing device 3000 includes one or more processors or processing units 3002, one or more memory and/or storage components 3004, one or more input/output (I/O) devices 3006, and a bus 3008 that allows the various components and devices to communicate with one another. Bus 3008 represents one or more of any of several types of bus structures, including a memory bus or memory controller, a peripheral bus, an accelerated graphics port, and a processor or local bus using any of a variety of bus architectures. Bus 3008 can include wired and/or wireless buses.

Memory/storage component 3004 represents one or more computer storage media. Component 3004 can include volatile media (such as random access memory (RAM)) and/or nonvolatile media (such as read only memory (ROM), flash memory, optical disks, magnetic disks, and so forth). Component 3004 can include fixed media (e.g., RAM, ROM, a fixed hard drive, etc.) as well as removable media (e.g., a Flash memory drive, a removable hard drive, an optical disk, and so forth).

One or more input/output devices 3006 allow a user to enter commands and information to computing device 3000, and also allow information to be presented to the user and/or other components or devices. Examples of input devices include a keyboard, a cursor control device (e.g., a mouse), a microphone; a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While preferred embodiments have been described herein, those skilled in the art, having benefit of this disclosure, will appreciate that other embodiments are envisioned that do not depart from the inventive scope of the present application. Accordingly, the scope of the present claims or any subsequent related claims shall not be unduly limited by the description of the embodiments herein.

What is claimed is:

1. A method, comprising:
providing a computer system having a memory and central processing unit;
populating a knowledge store residing in the computer system with data;
providing one or more computerized contextual earth models; and
using the one or more computerized contextual earth models to dynamically incorporate and economically validate one or more drilling decisions.

2. The method of claim 1, wherein the data comprise correlated data from one or more offset wells.

3. The method of claim 2, wherein the correlated data arc correlated by one or more of formation, depth, and time.

4. The method of claim 1, further comprising tracking a position of a well with respect to the one or more earth models.

5. The method of claim 1, wherein the one or more earth models are updated in real-time.

6. The method of claim 1, further comprising providing a real-time data link, and streaming the data in real-time using the real-time data link.

7. The method of claim 1, further comprising importing a drilling risk prediction model.

8. The method of claim 1, further comprising evaluating at least one of the cost and risks for a plurality of possible drilling scenarios; and selecting a scenario from the plurality of possible drilling scenarios that optimizes a field development drilling plan.

9. The method of claim 1, further comprising performing a collision avoidance analysis.

10. The method of claim 1, wherein using the one or more computerized contextual earth models to dynamically incorporate and economically validate one or more drilling decisions comprises monitoring execution of a drill plan in real-time.

11. The method of claim 1, wherein using the one or more computerized contextual earth models to dynamically incorporate and economically validate one or more drilling decisions comprises weighing a projected cost of additional drilling against a potential additional recovery of producible material.

12. The method of claim 1, wherein using the one or more computerized contextual earth models to dynamically incorporate and economically validate one or more drilling decisions comprises minimizing geologically driven risk by visualizing the risks in the context of the earth models, and monitoring the impact of changes in geology interpretation on the drilling process.

13. The method of claim 1, wherein using the one or more computerized contextual earth models to dynamically incorporate and economically validate one or more drilling decisions comprises computing optimized well trajectories.

14. The method of claim 1, wherein using the one or more computerized contextual earth models to dynamically incorporate and economically validate one or more drilling decisions comprises at least one of using bidirectional workflows and analyzing multiple case scenarios.

15. The method of claim 1, wherein populating the knowledge store comprises at least one of: incorporating historical data from multiple sources in multiple formats; connecting to a real-time data source and streaming data; and correlating multiple sources of data in different formats.

16. The method of claim 1, further comprising performing cross-discipline collaboration.

17. A system having a computer-readable medium having a set of computer-readable instructions encoded thereon that, when executed, perform acts comprising:
populating a knowledge store residing in the system with data;
representing one or more computerized contextual earth models; and
dynamically incorporating and economically validating one or more drilling decisions.

18. A method to perform well drilling operations, comprising:
collecting real-time drilling data;
generating a drilling data knowledge store using at least the drilling data; and
planning a well using the drilling data knowledge store.

19. The method of claim 18, further comprising displaying the real-time drilling data to show a plurality of correlated offset wells simultaneously.

20. The method of claim 18, further comprising displaying the collected drilling data within the context of a shared earth model.
